(19) United States
(12) Patent Application Publication
(10) Pub. No.: US 2019/0107225 A1
(43) Pub. Date: Apr. 11, 2019

(54) PUMP CHUCK WITH WHISTLING FUNCTION

(71) Applicants: Gregory Alan Ward, Pasadena, CA (US); Wen C. Hsieh, Rancho Dominguez, CA (US)

(72) Inventors: Gregory Alan Ward, Pasadena, CA (US); Wen C. Hsieh, Rancho Dominguez, CA (US)

(21) Appl. No.: 15/726,435

(22) Filed: Oct. 6, 2017

(51) Int. Cl. F16K 37/00; F16K 15/20

(52) U.S. Cl. CPC F16K 37/0066; F16K 15/207

(57) ABSTRACT

A pump chuck includes a main body, a pivot clip connected pivotally to an end cap of the main body, and a whistle assembly mounted in the main body. The end cap is rotatable relative to the main body for selecting one of valve holes in the end cap to connect with a valve stem of a tire and fixed thereat by the pivot clip. The whistle assembly does not generate a sound in a state that the whistle assembly receives a normal air pressure, but generates a whistling sound when the air pressure in the tire exceeds a preset pressure so as to prevent the tire being inflated from puncture or damage.

### BACKGROUND OF THE INVENTION

### 1. Field of the Invention

The present invention relates generally to a pump chuck, and more particularly to a pump chuck for a pumping apparatus that is rotatable in order to select a valve stem hole compatible with a valve stem of a bicycle tire to be inflated and that is adapted to generate a whistling sound once the connected bicycle tire is inflated to an excessive pressure by the pumping apparatus.

### 2. The Prior Arts

A pump chuck is a type of tool that connects the valve stem of a bicycle tire with a pumping source in order to inflate the bicycle tire. During the pumping operation, the valve stem of the bicycle tire should establish a hermetically sealing effect with a valve stem hole of the pump chuck while the other end of the pump chuck is connected with a pumping apparatus or a manually operated flexible hose. To inflate the bicycle tire, the pump chuck must be connected hermetically with the valve stem so as to prevent leakage of pumping pressure from a connecting portion between the pump chunk and the valve stem of the bicycle tire.

However, it is noticed that the presently existing conventional pump chuck does not possess the reminding function indicating whether the bicycle tire being inflated is fully injected with pressure or not. Under this condition, the bicycle tire may not be sufficiently inflated or in case of over inflated, a puncture may occur and hence damaging the bicycle tire being inflated.

In addition, the conventional pump chuck includes a connecting body and a pivot flap that is required to be moved into a pivoted position with respect to the connecting body during the connecting process only then the connecting body will be disposed fully and sealedly connected with the valve stem of the bicycle tire such that the dimension of the conventional pump chuck is increased. Under this condition, the configuration of the conventional pump chuck at the pivoted position hinders smooth inflating of a bicycle tire if the bicycle tire is of a small size. In other words, it is inconvenient and difficult to dispose the conventional pump chuck between adjacent pair of spokes for connecting with the valve stem of the bicycle tire of small dimension.

### SUMMARY OF THE INVENTION

A primary objective of the present invention is to provide a pump chuck for a pumping apparatus that is adapted to generate a whistling sound once the connected bicycle tire is fully inflated by the pumping apparatus.

Another objective of the present invention is to provide a pump chuck having valve stem holes of different specifications for a pumping apparatus that is adapted to be selected for connection with valve stems of different specifications for different bicycle tires.

Yet another objective of the present invention is to provide a pump chuck for a pumping apparatus that is adapted to be connected easily with a valve stem of small size bicycle tire.

A pump chuck with whistling function for a pumping apparatus according to the present invention includes: a main body, a pivot clip and an end cap pivotally connected to the main body respectively, and a whistle assembly disposed in the main body. The end cap is rotatable relative to the main body for selecting one of valve stem holes in the end cap to connect with a valve stem of a tire and fixed therewith by the pivot clip. The whistle assembly generates no sound in a state when the whistle assembly receives a normal air pressure, and generates a whistling sound for alarming when the air pressure in the tire exceeds a preset value.

The main body has a top surface formed with a first bore and, a spring retention recess, a connecting part formed with a second bore at one end of the main body for connecting with a hose of a pumping apparatus, an inner passage extends from the second bore into the main body for communication with the first bore, and a whistle chamber formed with a plunger hole which is communication with the inner passage and is formed on the lower part of the main body.

The end cap is disposed rotatably on the top surface of the main body so as to be located above the first bore, has a second shaft hole and at least two valve stem holes located at two sides of the second bore, wherein one of the valve stem holes is aligned with the first bore for receiving the valve stem of a tire to be inflated. The end cap further has an opening on each of opposite sides in spatial communication with the valve stem hole respectively.

In one embodiment of the present invention, the top surface of the main body is further formed with a first shaft hole extending through thereof, a pivot axle passing through the first shaft hole and the second hole in the end cap so as to permit rotation of the end cap relative to the main body.

The pivot clip is connected pivotally to the main body and rotatable above the main body. The pivot clip has adjacent end provided with an engagement element and a retention recess formed on a bottom surface thereof such that two opposite ends of a spring may be retained in the retention recesses of the pivot clip and the main body. The whistle assembly is disposed within the whistle chamber of the main body and in spatial communication with the inner passage. The engagement member of the pivot clip can extend through one of the openings of the end cap and into one of the valve stem holes for fixing the valve stem of a tire, thereby preventing the valve stem from wobbling during the pumping operation.

The whistle assembly includes a whistle element, a sound block, an air plug with a plunger, a whistle spring and a sealing washer. The whistle element defines an air channel along its longitudinal length and a sound channel in spatial communication with the air channel. The sound block is disposed within the air channel of the whistle element, has a planar side facing and defining a gap with the sound channel. The whistle spring is disposed between the air plug and the whistle element for pressing the plunger into the whistle chamber. The sealing washer is sleeved around the air plug, wherein, after assembly of the whistle assembly within the whistle chamber of the main body, extension of the plunger into the plunger hole results in blocking communication between the whistle chamber and the inner passage and in case of excessive air pressure within the inner passage causes withdrawal of the plunger from the plunger hole into the whistle chamber, thereby establishing spatial communication between the inner passage and the whistle chamber and permitting escape of the excessive pressure to an exterior of the main body via the sound channel of the whistle element, which, in turn generates a whistling sound.

In one embodiment of the present invention, the pivot clip is pivoted within pivot holes formed on the main body.

For connecting the valve stem of a bicycle tire to be inflated, the pivot clip is pivoted first of all toward the main body in order to align and permit extension of the valve stem into one of the valve stem holes of the end cap and the first bore, where the pivot clip is released to move back to its initial position by virtue of restoration force of the spring such that the engagement member passes through the opening for abutting against the valve stem of the bicycle tire to retain the same stably on the valve stem hole of the end cap.

During the inflating process, the compressed air from the pumping apparatus passes through the hose, the second bore, the inner passage and the first bore in the main body and enters into the valve stem of the bicycle tire. Once the bicycle tire is fully inflated, the excessive air pressure in the inner passage force the plunger moves axially toward the whistle chamber and causes the excessive air pressure from the bicycle tire escapes to an exterior of the main body via the inner passage, the whistle chamber and the gap defined between the sound block and the sound channel of the whistle element, thereby generating a whistling sound. In other words, explosion of the bicycle tire being inflated can be avoided due to escape of the excessive pressure from the main body generating a whistling sound for alarming.

In another embodiment of the present invention, one of the valve stem holes in the end cap is compatible with a Schrader valve and the remaining one of the valve stem holes in the end cap is compatible with a Presta valve. Users may rotate the end cap for selecting one of the stem holes to align with the first bore so as to receive the Schrader valve or the Presta valve.

It is noticed that since the valve stem holes in the end cap are of different sizes and therefore are compatible with the valve stems of different specifications, thereby facilitating in injection of pressure into different bicycle tires.

In this embodiment, there are only two valve stem holes having the profiles or configurations compatible with the Schrader valve and the Presta valve, the number of the valve stem holes and their profiles should not be limited only to the disclosed ones, many other variation, like English Valve, should also be included.

With the pump chuck of the present invention, the user can inflate bicycle tires of different specifications. Due to implementation of the whistling assembly, the user can stop the pumping operation once he or she hears the whistling sound indicating that the bicycle tire being inflated is full. In other words, explosion of the bicycle tire being inflated can be avoided. Moreover, in case of injecting air pressure into a bicycle tire of small size, pivotal action of the pivot clip toward the main body can result in small dimension such that the pump chuck of the present invention can be easily connected with the small size bicycle tire.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is a perspective view of a pump chuck of the present invention for pumping apparatus;

FIG. 1B is an exploded view of is the pump chuck of the present invention for pumping apparatus;

FIG. 1C is a cross-sectional view of the pump chuck of the present invention for pumping apparatus shown in FIG. 1A;

FIG. 2 is a perspective view of an end cap employed in the pump chuck of the present invention for pumping apparatus;

FIG. 3 is a perspective view of a pivot clip employed in the pump chuck of the present invention for pumping apparatus;

FIGS. 4A and 4B respectively show the pump chuck of the present invention for pumping apparatus in application; and

FIG. 5 shows the pump chuck of the present invention for pumping apparatus in application from a different angle.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

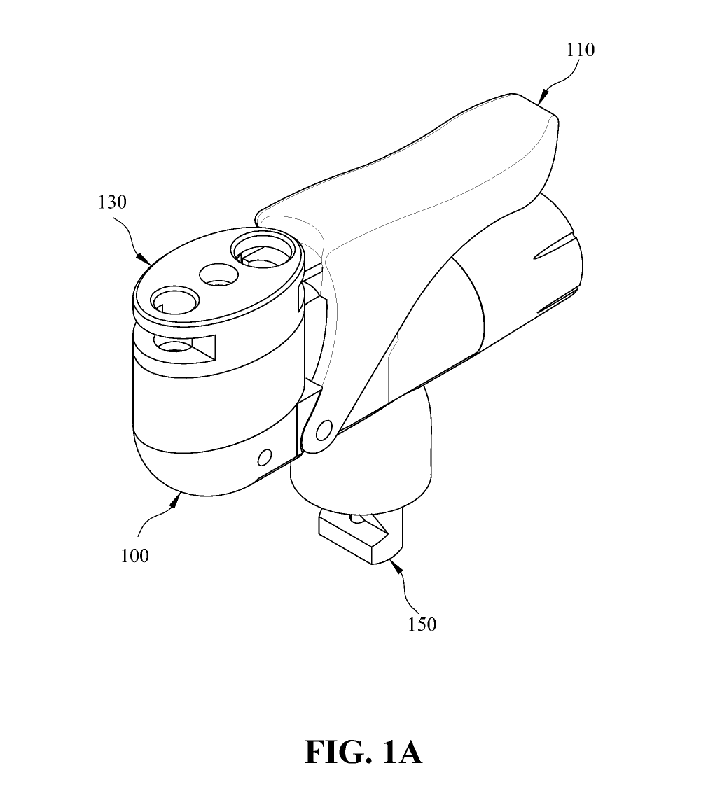

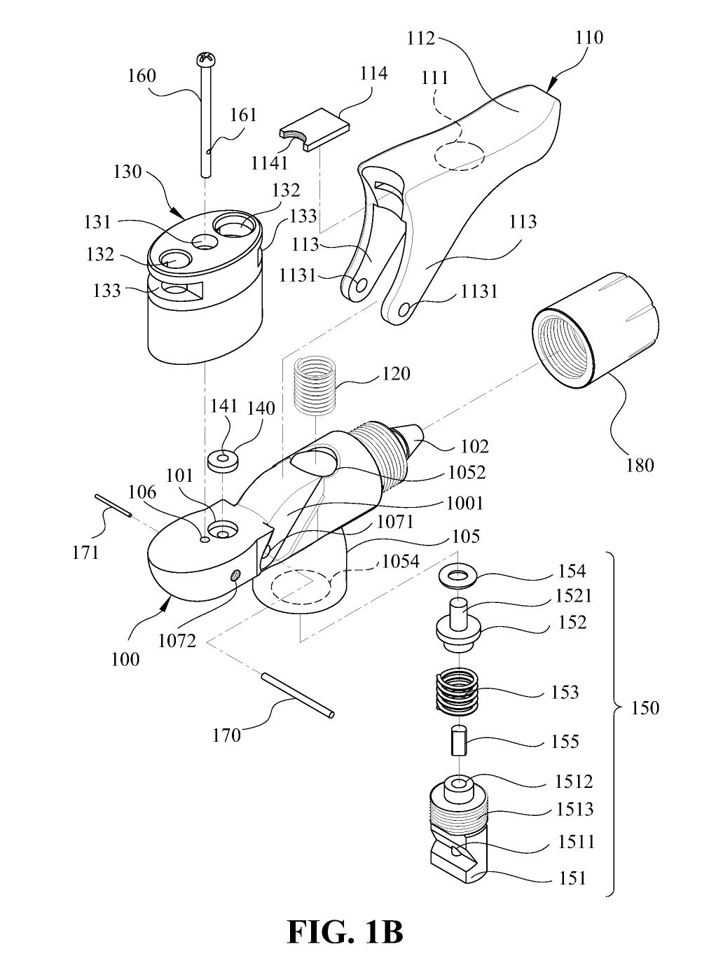

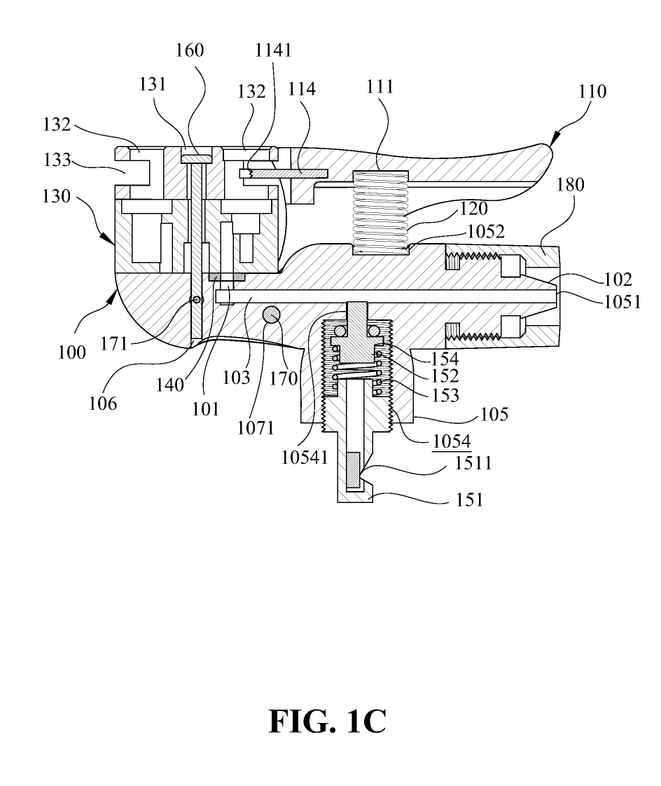

Referring to FIGS. 1A-1C, wherein FIG. 1A is a perspective view of a pump chuck of the present invention for pumping apparatus; FIG. 1B is an exploded view of the pump chuck of the present invention for pumping apparatus; and FIG. 1C is a cross-sectional view of the pump chuck of the present invention for pumping apparatus shown in FIG. 1A. As shown, the pump chuck with whistling function according to the present invention includes: a main body 100, a pivot clip 110, a spring 120, an end cap 130 and a whistle assembly 150.

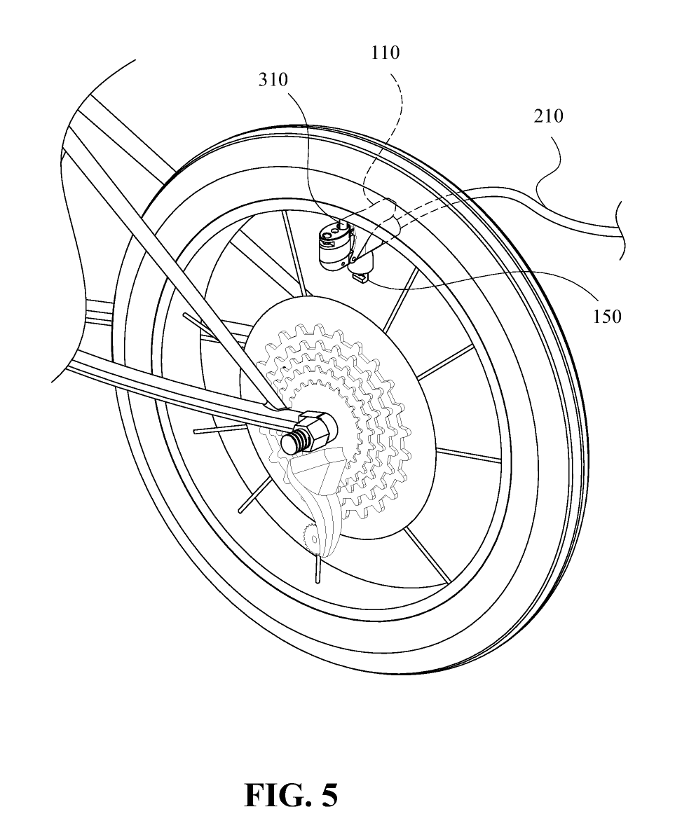

Referring to FIG. 1C, the main body 100 includes a connecting part 102 formed with a second hole 1051 at its free end, an inner passage 103 extending from the second hole 1051 into the main body 100, a first shaft hole 106 and a first bore 101 are formed on the top surface of a front section of the main body 100, a spring retention recess 1052 is formed on the top surface of a rear section of the main body 100, and a whistle chamber 1054 formed on the bottom surface of the main body 100, wherein, the first bore 101 has an upper large-diameter section, a lower narrow-diameter section in spatial communication with the inner passage 103 and a shoulder between the upper large-diameter and lower narrow-diameter sections such that a sealing washer 140 with a washer hole 141 is disposed on the shoulder within the first bore 101 and the washer hole 141 is aligned with the narrow-diameter of the first bore 101. Preferably, the sealing washer 140 is annular and is fabricated from flexible materials to provide sealing effects. The spring retention recess 1052 is formed on the top surface of the main body 100 for receiving a spring. The connecting part 102 is formed at a free end of the main body 100 for connecting a hose 210 (see FIG. 5) which is connected with a pump (not shown), the pump applies compressed air into a bicycle tire via the hose 210 and the connecting part 102 of the main body 100.

To be more specific, a second bore 1051 is formed at the free end of the connecting part 102 and extending into the main body 100 along the longitudinal direction thereof for forming the inner passage 103, wherein, the axes of the first bore 101 and the second bore 1051 may be perpendicular to each other within the inner passage 103.

The bottom surface of the main body 100 has a hollow cylinder 105 defining a whistle chamber 1054 along its axis and having a plunger hole 10541 extending upward from the whistle chamber 1054 for spatial communication with the inner passage 103, e.g. the axes of the whistle chamber 1054 and inner passage 103 may be perpendicular each other. Note that during the inflating process of a tire, the compressed air from the pumping apparatus (not shown) flows through the second bore 1051, the inner passage 103 and the first bore 101.

The rear section of the main body 100 is formed with two lateral sides 1001 inwardly indented with pivot holes 1071 and the front section of the main body 100 is also formed with two pivot holes 1072, the purpose of which will be given in the following paragraphs.

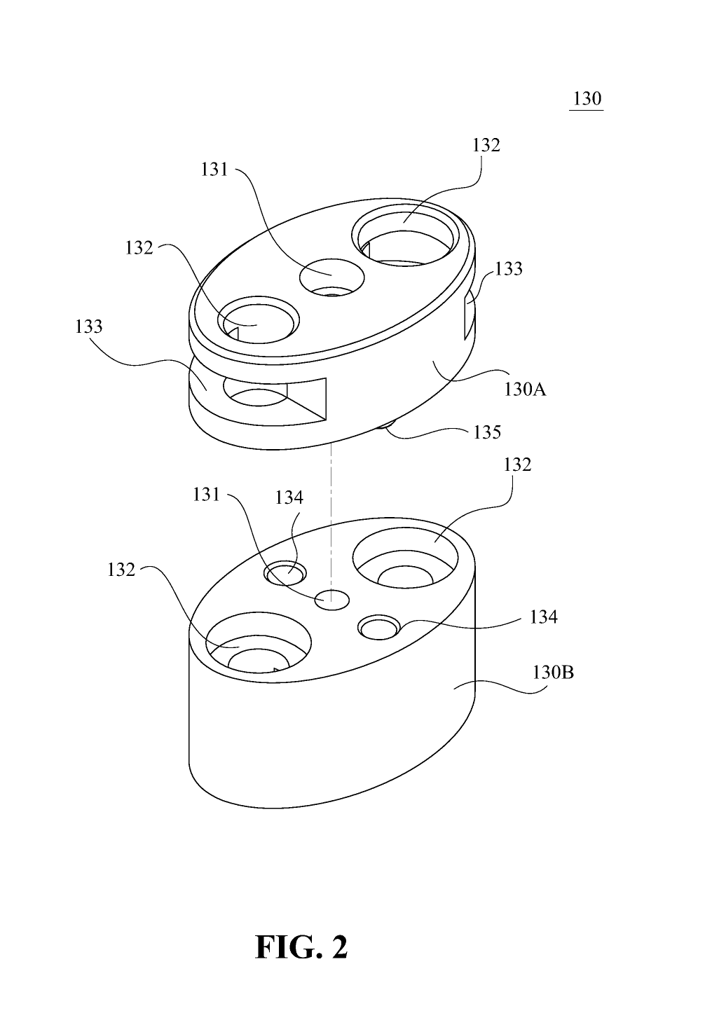

FIG. 2 is a perspective view of an end cap employed in the pump chuck of the present invention for pumping apparatus. Referring to FIG. 2, the end cap 130 is disposed rotatably on the top surface of the main body 100, has a second shaft bore 131 and two valve stem holes 132 located at two sides of the second shaft hole 131, preferably the second shaft hole 131 and the two valve stem holes 132 are arranged in a line such that the second bore 131 and the valve stem holes 132 are disposed at the same level and hence rotation of the end cap 130 relative to the main body 100 in 180 degrees can dispose one of the valve stem holes 132 in spatial communication with the first bore 101 in the main body 100. The end cap 130 further has two opposite lateral sides, each is formed with an opening 133 in spatial communication with a respective one of the valve stem holes 132. In this embodiment, the end cap 130 consists of an upper cover body 130A formed with the second shaft hole 131 and the two valve stem holes 132, and a lower cover body 130B such that the valve stem holes 132 terminates in the lower cover body 130B, but the second shaft hole 131 extends through the lower cover body 130B. To prevent disengagement, the bottom side of the upper end cap 130A has two stubs 135 extending into two engaging holes 134 in the lower end cap 130B, thereby fastening the upper and lower end caps 130A, 130B and preventing relative movement in the sidewise direction.

In the above embodiment, the end cap 130 is disposed rotatably on the top surface of the main body 100 and is located above the first bore 101. In particular, a pivot axle 160 extends through the second shaft hole 131 of the end cap 130 and the first shaft hole 106 of the main body 100 in turn so as to permit rotation of the end cap 130 relative to the main body 100. Preferably, the pivot axle 160 has a radial through hole 161 permitting a pivot pin 171 to pass through, which in turn, is connected to two pivot holes 1072 of the main body 100, thereby preventing untimely disengagement of the end cap 130 from the main body 100. Also, the rotation of the end cap 130 relative to the main body 100 in 180 degrees can dispose one of the valve stem holes 132 in spatial communication with the first bore 101 in the main body 100 for receiving a valve stem 310. The free end of the valve stem 310 will abut against on the bottom of the valve stem hole 132 when the valve stem 310 is inserted into the valve stem hole 132 and the first bore 101. The surrounding between the stem hole 132 and first bore 101 will be sealed hermetically due to the sealing washer 140 disposed on the shoulder within the first bore and compressed by the top surface of the body 100 and the bottom surface of the lower end cap 130B for preventing the air leakage.

It is to note that since the valve stems 310 of bicycle tires are generally two types, one of the valve stem holes 132 is compatible with a Schrader valve and the remaining one of the valve stem holes 132 is compatible with a Presta valve. The number of valve stem holes 132 should not be limited only to the disclosed ones, any other configuration, like English Valve, should also be included.

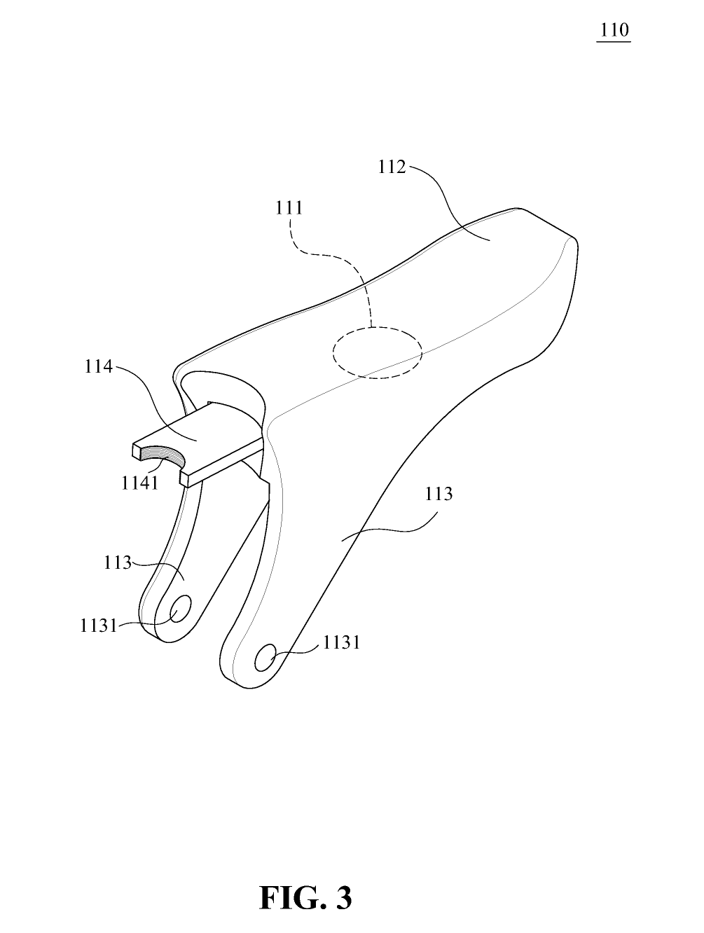

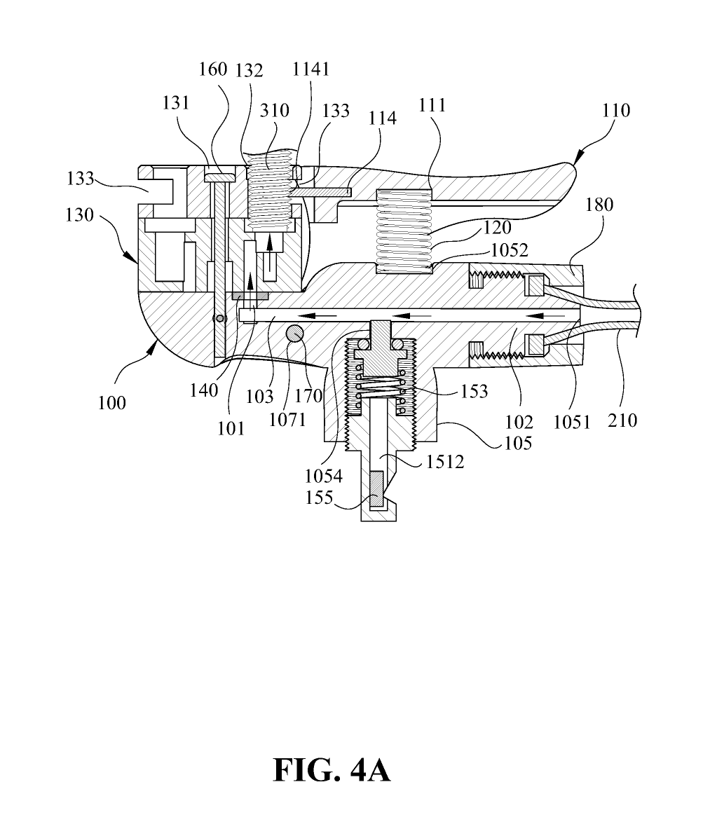

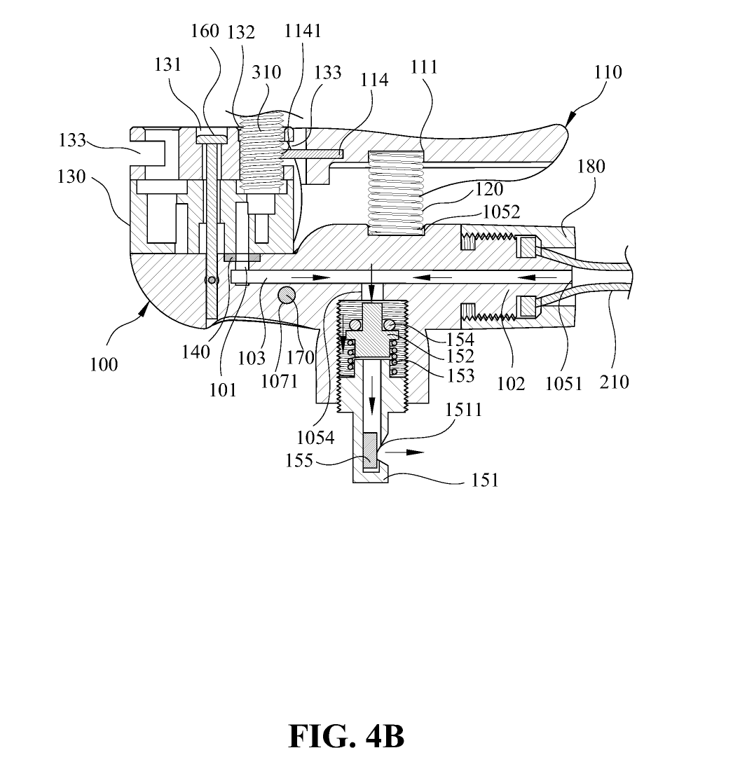

The pivot clip 110 is connected pivotally to the main body 100 and is rotatable relative thereto. The pivot clip 110 has an adjacent end provided with an engagement member 114 protruding toward to the end cap 130. For example, one end of the engagement element 114 may be fixed into a slot of the pivot clip 110 and the other end protrudes out of the pivot clip 110 (see FIG. 1B and FIG. 3). FIG. 3 also discloses the structure of the pivot clip 110, wherein the pivot clip 110 has an extension portion 112 and a pair of lateral arms 113 extending downwardly and aslant from one end of the extension portion 112, each is formed with a pivot hole 1131. A pivot shaft 170 passes through the pivot holes 1131, 1071 of the lateral arms 113 and the main body 100, thereby pivotally mounting the pivot clip 110 with the main body 100. Under this condition, the lateral arms 113 of the pivot clip 110 are disposed in the inwardly indented two lateral sides 1001 of the main body 100. In other words, the lateral arms 113 of the pivot clip 110 are flush with the outer peripheral surface of the main body 100. Perfectly, the engagement member 114 is a metal plate that has one end fixedly inserted into one slot in the adjacent end of the extension portion 112 and the other end defining a notch confined by a notch-defining wall formed with treads 1141 for providing friction once the notch-defining wall abuts against the valve stem 310 of the bicycle tire (see FIGS. 4A and 4B), thereby retaining the valve stem 310 of the bicycle stably on the valve stem hole 132.

The engagement element 114 extends into one of the valve stem holes 132 via one of the two openings 133 of the end cap 130 such that the spring 120 disposed between the pivot clip 110 and the main body 100 pushes the pivot clip 110 upward in such a manner to push the engagement member 114 toward an axis of the valve stem hole 132 such that once a valve stem 310 of a bicycle tire (see FIG. 4A) is connected to the valve stem hole 132, the notch with treads 1141 of the engagement member 114 abuts against the valve stem 310 of the bicycle tire, thereby retaining the valve stem 310 of the bicycle stably on the valve stem hole 132.

Moreover, a retention recess 111 may be formed on the bottom surface of the extension portion 112 of the pivot clip 110 such that two opposite ends of the spring 120 are retained in the retention recesses 1052, 111 such that in the normal condition, the spring 120 presses the pivot clip 110 upward and pushing the engagement member 114 toward an axis of the valve stem hole 132 in the end cap 130.

Referring again to FIG. 1B, the whistle assembly 150 is disposed within the whistle chamber 1054 of the main body 100, and includes: a whistle element 151 defining an air channel 1512 along its longitudinal length and a sound channel 1511 at a lateral side and in spatial communication with the air channel 1512; a sound block 155 disposed within the air channel 1512, having a planar side facing and defining a gap with the sound channel 1511; an air plug 152 having an annular flange and a plunger 1521 extending from the annular flange; and a whistle spring 153 disposed between the air plug 152 and the whistle element 151 to push the air plug 152 in such a manner to insert the plunger 1521 into the plunger hole 10541 of the whistle chamber 1054; and a sealing washer 154 sleeved around the plunger 1521 of the air plug 152.

Referring to FIGS. 4A and 4B, after assembly of the whistle assembly 150 within the whistle chamber 1054 of the main body 100, insertion of the plunger 1521 into the plunger hole 10541 results in blocking communication between the plunger hole 10541 and the inner passage 103 such that when it is desired to inflate a bicycle tire, the flexible hose 210 of a pumping apparatus is connected threadedly to the connection part 102 of the main body 100, then select and locate one valve stem hole 132 of the end cap 130 to be compatible with the valve stem of the bicycle tire to be inflated. After which, the pivot clip 110 is pivoted toward the main body 100 by pressing in order to insert the valve stem 310 into the valve stem hole 132, thereby establishing spatial communication with the first bore 101 in the main body 100.

Upon release of the pressing, the pivot clip 110 will retrieve to its initial position by virtue of pressing action of the spring 120, where the notch with treads 1141 of the engagement member 114 abuts frictionally against the valve stem 310 of the bicycle tire, thereby retaining the valve stem 310 stably on the valve stem hole 132 in the main body 100. In this embodiment, the treads 1141 is of M6 X 1.0P American type, and hence provides a sealing effect between the valve stem 310 and the valve stem hole 132.

Note that to avoid untimely disengagement of the flexible hose 210 of the pumping apparatus from the connecting part 102 of the main body 100, a tubular sleeve 180 is mounted threadedly on the connecting part 102 of the main body 100 to facilitate connection of the flexible hose 210 with the connection part 102.

Upon activation of the pumping apparatus (not visible), the compressed air from the pumping apparatus enters into the valve stem 310 of the bicycle tire after passing through the flexible hose 210, the second bore 1051, the inner passage 103, the first bore 101 and the valve stem hole 132 in the end cap 130, as best shown in the arrow direction of FIG. 4A. Note that since the plunger 1521 of the air plug 152 extends hermetically into the plunger hole 10541 of the whistle chamber 1054 by pressing action of the whistle spring 153 and since the inner passage 103 is not tight with pressure, no pressure will enter into the whistle chamber and hence no whistling sound will be generated at this time (during the inflating process of the bicycle tire).

As shown in FIG. 4B, once the bicycle tire being inflated is fully inflated such that no more compressed air can enter into the valve stem 310 of the bicycle tire, the excessive compressed air pressure in the inner passage 103 forces the plunger 1521 moving axially, as shown by arrow directions, causes withdrawal of the plunger 1521 from the plunger hole 10541 into the whistle chamber 1054, thereby establishing spatial communication between the inner passage 103 and the whistle chamber 1054 and permitting escape of the excessive air pressure to an exterior of the main body 100 via the sound channel 1511 of the whistle element 151 and generating a whistling sound for alarming. In other words, puncture of the bicycle tire being inflated can be avoided.

Note that in order to provide leak-proof effects during the inflating process, a sealing washer 154 is sleeved around the plunger 1521 of the air plug 152 such that the outer periphery sealedly contacts the periphery confining the plunger hole 10541 of the whistle chamber 1054.

Also note that after the pump chunk of the present invention is connected with the valve stem of a bicycle tire to be inflated and/or during the inflating process of the bicycle tire, the lower part of the main body 100 containing the whistle assembly 150 is oriented toward an exterior of the tire being inflated so that no hindrance is caused to the inflating process.

FIG. 5 shows the pump chuck of the present invention for pumping apparatus in application from a different angle. Note that compression of the pivot clip 110 relative to the main body 100 can reduce an overall dimension of the pump chuck of the present invention. Under this condition, the pump chuck of the present invention can be easily inserted into two adjacent spokes of a small-size bicycle wheel even if the two spokes are closely located so as to facilitate mounting of the valve stem 310 of the bicycle tire into the valve stem hole 132 of the end cap 130, thereby eliminating the problem of mounting the conventional pump chuck on the valve stem of small-size bicycle tire encountered in the prior art. Moreover, the pumping person can immediately stop the inflating process once he hears the whistling sound informing that the bicycle tire being inflated is full. In other words, undesired explosion of the tire being inflated can be avoided.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A pump chuck with whistling function, comprising:
a main body having a top surface formed with a first bore and further defining an inner passage in spatial communication with said first bore, a bottom surface formed with a whistle chamber having a plunger hole in spatial communication with said inner passage, and a connecting part defining a second bore in spatial communication with said an inner passage;
an end cap disposed rotatably on said top surface of said main body, having a second shaft hole and two valve stem holes located at two sides of said second shaft hole such that said second shaft hole and said valve stem holes are disposed at the same level such that rotation of said end cap relative to said main body can dispose one of said valve stem holes in spatial communication with said first bore in said main body, said end cap further having two opposite lateral outside walls, each formed with an opening in spatial communication with a respective one of said valve stem holes;
a pivot clip connected pivotally to said main body, having an adjacent end formed with an engagement member extending into one of said valve stem holes via one of said two openings of said end cap;
a spring disposed between said pivot clip and said main body for pressing said pivot clip toward said end cap in such a manner to push said engagement member toward an axis of said valve stem hole such that once a valve stem of a bicycle tire is connected to one of said valve stem holes, the valve stem of the bicycle is maintained stably on said one of said valve stem holes due to abutment between said engagement member and the valve stem of the bicycle tire; and
a whistle assembly disposed within said whistle chamber of said main body, including: a whistle element defining an air channel along its longitudinal length and a sound channel in spatial communication with said air channel; a sound block disposed within said air channel and having a planar side facing the sound channel and defining a gap with said sound channel, an air plug having an annular flange and a plunger extending from said annular flange, a whistle spring disposed between said air plug and said whistle element in such a manner to force said plunger of said air plug into said plunger hole, and a washer sleeved around said plunger of said air plug;
wherein, after assembly of said whistle assembly within said whistle chamber of said main body, extension of said plunger into said plunger hole due to pressing action of said whistle spring results in blocking communication between said whistle chamber and said inner passage and in case of excessive air pressure within said inner passage causes withdrawal of said plunger from said plunger hole into said whistle chamber, thereby establishing spatial communication between said inner passage and said whistle chamber and permitting escape of said excessive air pressure to an exterior of said main body via said sound channel of said whistle element and hence generating a whistling sound.

2. The pump chuck according to claim 1, wherein said whistle chamber has an inner wall surface formed with inner threads, said whistle element has an external wall surface formed with outer threads for fastening threadedly with said inner threads of said whistle chamber.

3. The pump chuck according to claim 2, wherein said first bore has an upper large-diameter section, a lower narrow-diameter section and a shoulder between said large-diameter and narrow-diameter sections, the pump chuck further comprising a sealing washer with a washer hole disposed on said shoulder within said first bore such that said washer hole is aligned with said narrow-diameter section of said first bore.

4. The pump chuck according to claim 3, wherein said top surface of said main body is further formed with a first shaft hole extending parallel with said first bore, a pivot axle extends through said second shaft hole of said end cap and said first shaft hole of said main body so as to permit rotation of said end cap relative to said main body, wherein said end cap has upper and lower end bodies of an over shape generally flush with the profile of said top surface of said main body.

5. The pump chuck according to claim 4, wherein said pivot axle has a radial through hole permitting extension of a pivot pin, through the pivot holes of the main body once the pivot axle inserted into the second and first shaft holes, thereby preventing untimely disengagement of said end cap from said main body.

6. The pump chuck according to claim 5, wherein one of said valve stem holes is compatible with a Schrader valve and the remaining one of said valve holes is compatible with a Presta valve.

7. The pump chuck according to claim 6, wherein said main body has two lateral sides, each formed with a pivot hole, said pivot clip has two lateral arms extending downwardly from said adjacent end and each is formed with a pivot hole, a pivot shaft extending through said pivot holes of said pivot clip and said main body, thereby pivotally mounting said pivot clip on said main body.

8. The pump chuck according to claim 7, wherein said main body is formed with two lateral sides inwardly indented with pivot holes and aslant extend to a rear section of the main body, and the lateral arms of the pivot clip are flush with an outer peripheral surface of the main body.

9. The pump chuck according to claim 8, wherein said engagement member is a metal plate having one end fixed to said adjacent end of said pivot clip and the other end defining a notch confined by a notch-defining wall formed with treads for providing friction once said notch-defining wall abuts against the valve stem of the bicycle tire, thereby retaining the valve stem of the bicycle stably on said valve hole.

10. The pump chuck according to claim 9, wherein said top surface of said main body is formed with a retention recess and said pivot clip has a lower surface formed with a retention recess such that two opposite ends of said spring are retained in said retention recesses.
